(19) United States
(12) Patent Application Publication
(10) Pub. No.: US 2004/0261100 A1
(43) Pub. Date: Dec. 23, 2004

(54) iChoose video advertising

(76) Inventors: Thomas Huber, Sammamish, WA (US); Thomas Lemmons, Evergreen, CO (US)

Correspondence Address: COCHRAN FREUND & YOUNG LLC, 3555 STANFORD ROAD, SUITE 230, FORT COLLINS, CO, 80525, US

(21) Appl. No.: 10/688,075

(22) Filed: Oct. 17, 2003

Related U.S. Application Data
(60) Provisional application No. 60/420,110, filed on Oct. 18, 2002.
(60) Provisional application No. 60/419,871, filed on Oct. 18, 2002.

(51) Int. Cl. H04N 5/445; G06F 3/00; H04N 7/10

(52) U.S. Cl. 725/32; 725/42

(57) ABSTRACT

Disclosed is a system for conditionally presenting selected categories of advertising to viewers. Advertisements may be included as part of a broadcast signal, may be acquired from a channel or MPEG stream different from a viewed program, may be downloaded from network including the Internet and may be stored locally in a set top box. Computer program code operating in a set top box selects an advertisement from a plurality of ads based upon indicator information including category and priority level. Viewer category selections may be entered by the user, may be selected in response to use of a personalized remote control, or may be provided in a pre-programmed set top box. Viewer requests for categories of advertisements or for specific advertisements may be processed by upstream equipment to formulate a broadcast schedule. Viewer may pay an upgrade fee for viewing upgraded advertising and/or advertisers may pay a fee based upon the number of times an ad is displayed.

### CROSS REFERENCE TO RELATED APPLICATIONS

This application is based upon and claims the benefit of U.S. Provisional Patent Application Ser. No. 60/420,110 by Thomas Huber and Thomas Lemmons entitled “iChoose Vide Advertising” filed Oct. 18, 2002 and U.S. patent application Ser. No. ______, by Thomas Lemmons entitled “Demographic/Preference Sniffer” filed Oct. 16, 2003, which is based upon U.S. Provisional Patent Application Ser. No. 60/419,871 by Thomas Lemmons, entitled “Demographic/Preference Sniffer” filed Oct. 18, 2002, which are hereby specifically incorporated herein by reference for all that they disclose and teach.

### BACKGROUND OF THE INVENTION

a. Field of the Invention

The present invention pertains generally to video technology and more specifically to selection of video advertising.

b. Description of the Background

Video programming and embedded advertising has typically been designed for certain segment lengths. Advertising segments are typically disbursed through the video programming. Segments may often be 30 seconds or 1 minute in length. Shorter segments may be 15 seconds in length. Certain segments may be designated for national advertising, while other segments may be designated for regional or local advertising. Advertisers pay for these video segments which are displayed universally to the viewers. Viewers generally do not have any input as to which advertisements are displayed on their televisions.

Advertisers have attempted to target their audiences based upon the content of the video program. For example, advertisers of toys may purchase advertising segments during cartoon shows. Advertisers of beer may purchase advertising segments during football games. This type of targeting of the audience has been somewhat effective. However, certain types of advertisements are frequently displayed to viewers who are not targeted. For example, underwear and beer commercials may be shown during family viewing time. Various groups of people may take offense to certain advertisements, especially if they are not within the targeted group. In addition, certain demographic groups may wish to view sexually oriented advertising or other adult type of advertising, such as beer and liquor commercials for all of their program viewing. Current methods of targeted advertising are ineffective for this type of selective targeted advertising.

### SUMMARY OF THE INVENTION

Embodiments of the present invention overcomes the disadvantages and limitations of the prior art by providing a system and method in which a viewer can select the type and/or level of advertising that the viewer would like to view and further provides an opportunity for feedback directly to the advertiser.

Embodiments of the present invention may therefore comprise a method of presenting advertising in a television broadcast system comprising: offering an upgraded advertising service; receiving subscriptions to the upgraded advertising service; delivering set top box computer program code to a plurality of upgraded advertising service subscribers; receiving a plurality of video feeds including a plurality of advertisements; providing indicators for at least two advertisements of the plurality of advertisements wherein the indicators include a priority level and a category for a corresponding advertisement; broadcasting a video signal comprising program content, the plurality of advertisements, and the indicators for at least two advertisements of the plurality of advertisements to a plurality of set top boxes.

Embodiments of the present invention may further comprise a method for displaying user selected advertising in a subscriber broadcast system comprising: requesting a category of advertisement from a plurality of advertisement categories; receiving a video signal comprising program content, a standard advertisement, and an advertisement indicator; determining if the standard advertisement may be replaced with an upgraded advertisement; accessing upgraded advertisement content if it is determined that the standard advertisement may be replaced with an upgraded advertisement; and displaying the upgraded advertisement content if it is determined that the standard advertisement may be replaced with an upgraded advertisement.

Embodiments of the present invention may further comprise an upgraded advertising production system comprising: a processor; an advertisement detector receiving a video feed comprising program content and advertising; an advertisement indicator editor that can create, modify, and delete at least one advertisement indicator associated with an advertisement contained in the video feed; a channel multiplexer that receives the program content, at least one advertisement, and the at least one advertisement indicator and that formats the program content, the advertisement and the at least one advertisement indicator for transmission; and a transmitter that transmits the program content, the advertisement, and the at least one advertisement indicator.

Embodiments of the present invention may further comprise a set top box that selectively displays upgraded advertising comprising: a processor; an audio/video processor that outputs audio and video signals to a display unit; a tuner controlled by the processor that receives a video input comprising program content, a first advertisement, a first advertisement indicator, a second advertisement, and a second advertisement indicator wherein the first advertisement indicator and the second advertisement indicator both include a category of the advertisement and a priority level; first computer program code operating on the processor that detects the first advertisement indicator and the second advertisement indicator and compares the category of the first advertisement and the category of the second advertisement to a stored category value and that compares the priority level of the first advertisement with the priority level of the second advertisement and that selects the first advertisement unless the category of the second advertisement is in agreement with the stored category value and the priority level of the second advertisement is greater than or equal to the priority level of the first advertisement; second computer program code that provides the first advertisement to the audio/video processor if the first advertisement is selected and that accesses and provides the second advertisement to the audio/video processor if the second advertisement is selected.

The advantages of the present invention are that a viewer can select the type and/or level of advertising the viewer wishes to view, rather than being faced with advertisements for which the viewer has no interest. The viewer can use any one or combination of selection choices including, without limitation, remote control selection at any time during viewing session or at beginning of viewing session, manual selection switches associated with a set top box, selection based on programming in a remote control device, selection based on who is using the remote control, pre-programmed set top box, etc. Selection may be integrated with a security process to require, for example, a password to order adult advertising. The viewer may be charged an upgrade fee to view the type and/or level of upgraded selected advertising that the viewer wishes to view. The viewer may have the ability to choose, the types of ads that the viewer wishes to view during the viewing process. Alternatively, set top boxes can be preprogrammed to show only certain types of pre-selected advertising. Further, personalized remote control devices can be recognized by a set top box to display certain categories of advertising. Also, feedback mechanisms can be used along with accounting and billing software to charge advertisers based upon selection of advertising packages, or individual usage of certain advertisements. In addition, selected advertising can be interspersed with mandatory or “standard” advertising so that the program stations can maintain certain control and income over the advertising packages.

Once the viewer has selected an upgraded advertising package, the viewer will be much more likely to view the ads. For example, a viewer that has selected an R-rated programming package may pay particular attention to and may look forward to the R-rated ads that are interspersed throughout the regular mandatory ads. In this manner, both the mandatory ads and the selected advertising will gain greater attention. Embodiments of the present invention may be applied to select the type or category of advertising content and/or the manner or style in which it is presented.

### BRIEF DESCRIPTION OF THE DRAWINGS

FIG. 1 is a schematic illustration of one embodiment in which a viewer may choose an upgraded advertising package.

FIG. 2 schematically illustrates the manner in which various set top boxes within a home can be preprogrammed for different advertising packages.

FIG. 3 is a block diagram of one embodiment of the present invention.

FIG. 4 is a flow diagram illustrating the steps of implementing real-time upgraded advertising.

FIG. 5 is a schematic block diagram of another embodiment of the present invention.

FIG. 6 is a flow diagram illustrating steps performed to implement upgraded advertising from locally stored advertising content.

FIG. 7 is a flow diagram illustrating steps performed to implement upgraded advertising acquired over a network interface.

FIG. 8 is a schematic diagram of yet another embodiment of the present invention.

FIG. 9 is a flow chart illustrating steps performed to implement stored video-on-demand advertising

FIG. 10 is a flow chart illustrating steps performed to implement real-time video-on-demand advertising.

FIG. 11 is a block diagram of a system for accounting and billing advertisers.

FIG. 12 is a schematic block diagram of an upgraded advertising system as may be implemented by a cable, satellite or other video services providers.

FIG. 13 is a flowchart illustrating steps performed in producing a video signal supporting upgraded advertising.

FIG. 14 is an operational overview of an upgraded advertising system.

### DETAILED DESCRIPTION OF THE INVENTION

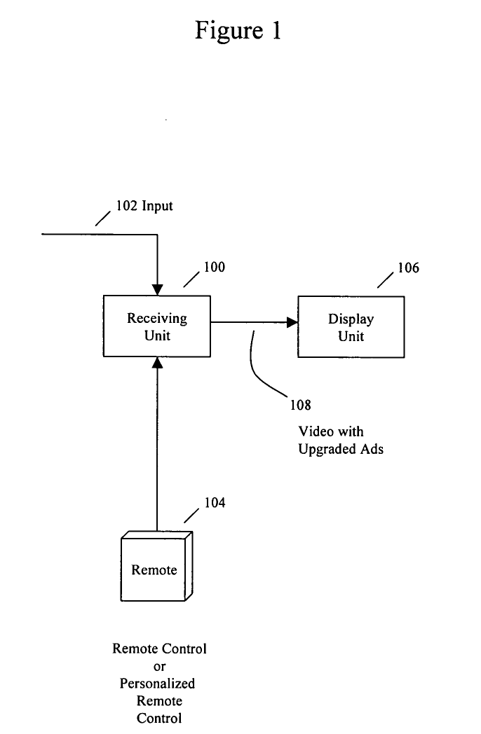

FIG. 1 is a schematic block diagram that illustrates the manner in which a viewer may access a receiving unit 100, such as a set top box, to select an upgraded advertising package. As disclosed throughout, a set top box can be any device that receives a broadcast comprising analog or digital signals, or a combination thereof, and provides signals to audio and video output devices, such as a television and speaker, for example, and is capable of carrying out any of the functions described for the receiving unit 100 or set top box, as disclosed in this application. As shown in FIG. 1, an input 102 may comprise an input signal from a cable network, a satellite receiver, a computer network input, stored media, or any other desired input that may include a video signal, triggers, tags, markers, upgraded advertising packages, etc., or any combination thereof. The input signal can comprise analog video signals, MPEG signals, base-band signals, packetized data, etc. and may include video information, interactive pages, interactive overlay images, HTML interactive pages, non-interactive overlay images, VRML, private data files, audio data, JPEG or other image data, Java files, and other software that may be run on the set top box, or any combination thereof. This type of input signal shall be collectively referred to hereinafter as a “video signal” or “input” with the exception of that specific portions of the video signal or input may be called out as separate elements, such as tags, markers, triggers, overlay pages, etc. The term “MPEG” has been employed in the description and operation of the embodiments of the present invention. It is expressly stated that any references to MPEG encompass any and all digital formats, public or proprietary, that allow transfer of digital information as described in this application.

The input 102 is applied to the set top box 100, in the embodiment of FIG. 1. In accordance with this embodiment, a viewer may use an input device 104 such as a remote control device, or a personalized remote control device, that is disclosed in U.S. patent application Ser. No. 09/941,148, filed Aug. 27, 2001 by Thomas Huber, Steven O. Markel, Ian Zenoni and Thomas Lemmons, entitled “Personalized Remote Control,” which is specifically incorporated herein by reference for all that it discloses and teaches. Accordingly, the user employs the personalized remote control device 104 to access the set-top box 100 to select an upgraded advertising package or to select the standardized advertising package. An upgraded advertising package may include a category of advertisements for which the viewer has particular interest. The viewer may, in fact, actually pay to have the upgraded advertising package which includes ads that are of a particular interest to the viewer. Alternatively, the viewer may receive rewards for viewing advertisements or a group of advertisements, as disclosed in U.S. patent application Ser. No. 10/099,054, filed Mar. 13, 2002 by Steven O. Markel, entitled “Affinity Marketing for Interactive Media Systems,” which is specifically incorporated herein by reference for all that it discloses and teaches. For example, some viewers may wish to only have family oriented advertising displayed, and hence, would use the remote control or personalized remote control 104 to select a family advertising package. As another example, other viewers may wish to view R-rated advertising in which nudity may be used in the advertisement to spark the interest of the viewer. As another example, the viewer may select a children's advertising package for young viewers. As another example, some viewers may wish to have ads directed to specific products or services, such as sporting equipment, or hunting equipment, or sewing and crafts, etc., for example, depending upon the particular interest of the viewer. Different levels of packages can also be provided. For example, different prices can be charged for different packages depending upon the content and the number of mandatory ads. The upgrade level may correspond to the ratio of upgraded ads shown to standard or mandatory ads shown.

In accordance with one embodiment, the viewer may be charged an upgrade fee to have access to various upgraded advertising packages that may be selected by the viewer on an individual viewing basis through the use of a menu. Alternatively, a personalized remote control could be used which identifies the particular viewer so that the set-top box either selects an upgraded advertising package based upon the identification of the viewer that is provided by the personalized remote control or provides a number of advertising packages based upon the identification of the viewer. For example, a menu may be displayed on the display device 106 when the viewer initially turns on the set top box 100. If the personalized remote control identifies the viewer as a child, a list of menus may be displayed on the display device 106 that are advertising packages directed to children. For example, an advertising package for toys or children's music may be displayed as a menu item. Of course, a generalized menu of items such as child ads that comprise a whole mix of advertising directed to children can be displayed. Alternatively, upgraded ads for children can be automatically selected by the set-top box once the set-top box recognizes the viewer as a child from the remote control device. Once an advertising package is selected, video with the upgraded ads is provided to the display 106 for viewing. Of course, other ways of selecting a video package may be used other than a remote control or personalized remote control 126, such as manual selection switches. These switches may also remain under lock and key, or may require entry of password for changes to be accepted, to prevent access by certain individuals. In this fashion, the viewer may choose the desired upgraded advertising package. Selection of an advertising package may result in the set top box communicating with upstream or networked equipment to indicate that an upgraded advertising package has been selected. Further, such communication may result in a downstream communication, or other network communication, that enables the set top box to display the selected advertising package. Such downstream communication may also comprise a category or set of categories for upgraded advertising that reflect a set of data, such as demographic data, for example, for a particular viewer or group of viewers such as disclosed in U.S. patent application Ser. No. ______, filed Oct. 16, 2003, by Thomas Lemmons, entitled “Demographic/Preference Sniffer,” which is specifically incorporated herein for all that it discloses and teaches.

Interspersed with the upgraded ads may be mandatory ads that are required to be displayed to the viewer. The mandatory ads provide revenue control and other advertising control over the process. As mentioned above, mandatory ads that are interspersed with upgraded ads will be more likely to be viewed by the viewer since the viewers of upgraded ads will be watching the advertisements more closely. Advertisers can be charged a higher fee for the mandatory ads since the mandatory ads will be displayed even though the viewers have selected an upgraded advertising package. Mandatory ads, of course, will have to meet certain criteria such as a G-rating that is suitable for viewing by all viewers. Higher levels of upgraded packages may have fewer mandatory ads, as disclosed above.

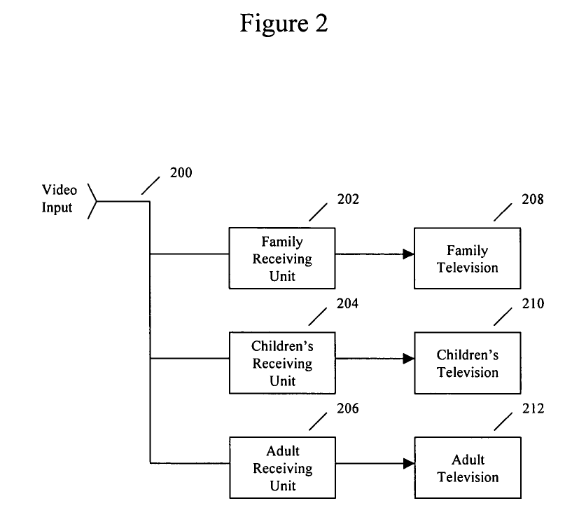

FIG. 2 is a schematic block diagram illustrating another embodiment of the present invention. As shown in FIG. 2, the video input 200 can comprise a standard cable TV input, a satellite feed, a wireless fee, or any other type of feed. The input 200 is feed to any one of a number of set-top boxes 202, 204, 206. These set-top boxes may be located in an individual home or business or in separate premises. As shown in FIG. 2, set-top box 202 is a family set-top box that is preprogrammed to only show family oriented advertising. The viewer may rent the set-top box 202 from the cable company and pay an upgraded fee each month to receive the family oriented advertising through set-to-box 202. The family set-top box 202 may be connected to the family TV 208, which only displays the family oriented advertising.

As also shown in FIG. 2, a children's set-top box 204 is connected to a children's TV that may be in the children's room. The children's set-top box 204 is preprogrammed to only display child oriented advertising on the children's TV 210. Embodiments of the present invention may also be employed to limit the types of advertising presented on the children's television, with the exception of mandatory advertising, such that certain types of advertisements, such as candy, violent toys, and the like may be reduced or eliminated. Again, the children's set-top box 204 may be rented from the cable company for an additional fee each month or may be purchased for a set fee. As also shown in FIG. 2, an adult set-top box 206 can be rented or purchased from the cable company, and is preprogrammed to show adult type advertising on the adult TV 212.

Alternatively, certain set-top boxes may be timed to show different types of advertising at different times. For example, a set-top box in a parents' bedroom may be programmed to display family ads during the day, sports ads in the early evening and R-rated ads in the late evening. Further, the receiving unit may be configured to show different types of advertising at different times on different days of the week, allowing advertising to be tailored to weekends or holidays, for example.

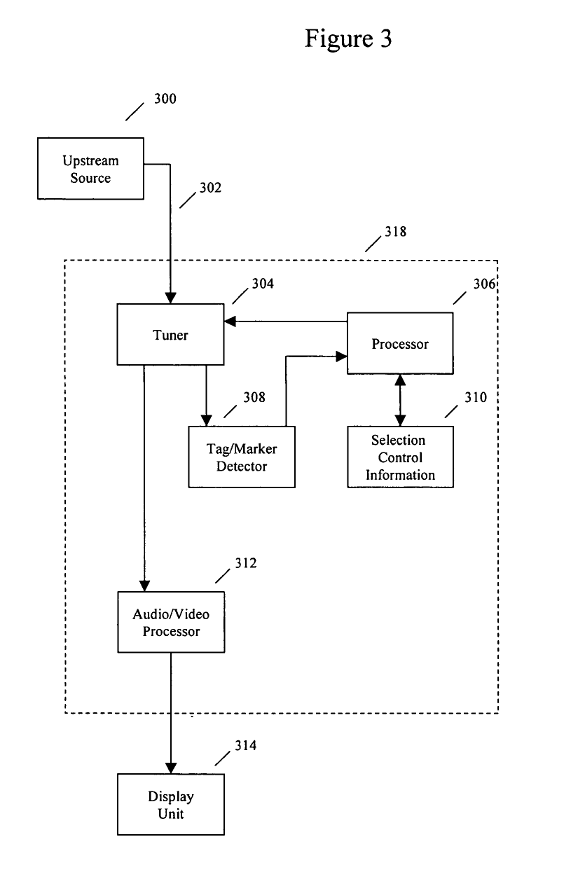

FIG. 3 is a schematic block diagram of one embodiment of the invention. As shown in FIG. 3, upstream source 302 provides input signal 302 to set top box 318. The upstream source can be a local distribution point, a head-end, a studio, a neighborhood distribution center, or other point at which signals may be distributed. For example, the upstream source may comprise a downlink station from a satellite receiver. In addition, the upstream source may be a local satellite receiver at the viewer's premises. The input signal 302 may include video signals in the form of analog video signals or MPEG data packets, or a combination of both. The input signal may include program content and standard advertisements as well as indicators, including but not limited to tags, markers, and triggers, wherein the indicators may be implemented as a signal or data packet contained in the vertical blanking interval of an analog format, or as a digital packet in a digital format. The indicators may be employed to provide information associated with standard advertisements. In one embodiment, indicators provide information for standard and upgraded advertisements and may be employed to signal to the set top box that upgraded advertisements are available. The indicator information may convey (directly or indirectly) beginning point, ending point, advertisement type, source (such as channel number), upgrade allowance, or other information for each of the advertisements that are included in the video signal. Indicators may employ methods disclosed in U.S. patent application Ser. No. 10/076,950, filed Feb. 12, 2002 by Ian Zenoni, entitled “Video Tags and Markers”, which is specifically incorporated herein by reference for all that it discloses and teaches. For example, markers may mark the beginning and/or ending of each advertising segment while tags may comprise a description of the ad. For example, the tags may indicate that a standard ad embedded in the video signal is a replaceable ad, or that the ad is a mandatory ad. Replaceable ads can be replaced by upgraded ads, while mandatory ads cannot be replaced. Alternatively, ads may have different priority levels so that higher-level upgraded advertising packages may replace lower level ads. Mandatory ads may be assigned the highest priority level. In embodiments providing various upgrade packages, ads with a specific priority level may be replaceable in some packages and may not be replaceable in other packages.

Input signal 302 is provided to tuner/decoder 304. Under control of processor 306, tuner 304 selects a frequency containing a video signal. Tag/Marker detector 308 is responsive to tag, marker, or other indicator information contained in the video signal and provides the information to processor 306. Tag/Marker 308 detector may support proprietary or public formats, or a combination thereof and may include support compliant with the Enhanced Content Specification of ATVEF (Advanced Television Enhancement Forum), for example. Tuner 304 provides the selected signal to audio/video processor 312 that transmits audio and video signals to display unit 314. Audio/video processor 312 may include MPEG decoding and analog signal processing. Upstream source 300 may include upgraded advertising. The upgraded advertising may be part of a broadcast associated with a program, or may be provided on a different frequency. For example, the frequency selected by tuner 304 may provide multiple MPEG streams where one of the streams provides program content and another stream provides upgraded advertising; or the frequency may provide an analog program and advertising. Upgraded advertising may be also provided on another frequency, or may be embedded in a digital format within the analog program, such as during blanking intervals, for example. In operation, processor 306 receives indicator information from tag/marker detector 308, applies an algorithm that employs the indicator information and information contained within selection control information 310, and determines if a different analog channel or digital stream will be processed by audio/video processor 312 during the standard advertisement. Selection control information may comprise tables, indexes, key words, priority levels, and other information for one or more categories of upgraded advertising. Indicator information may be provided at a time prior to the commencement of advertising to allow sufficient time for processor 312 to determine the analog channel or digital stream employed to display advertising.

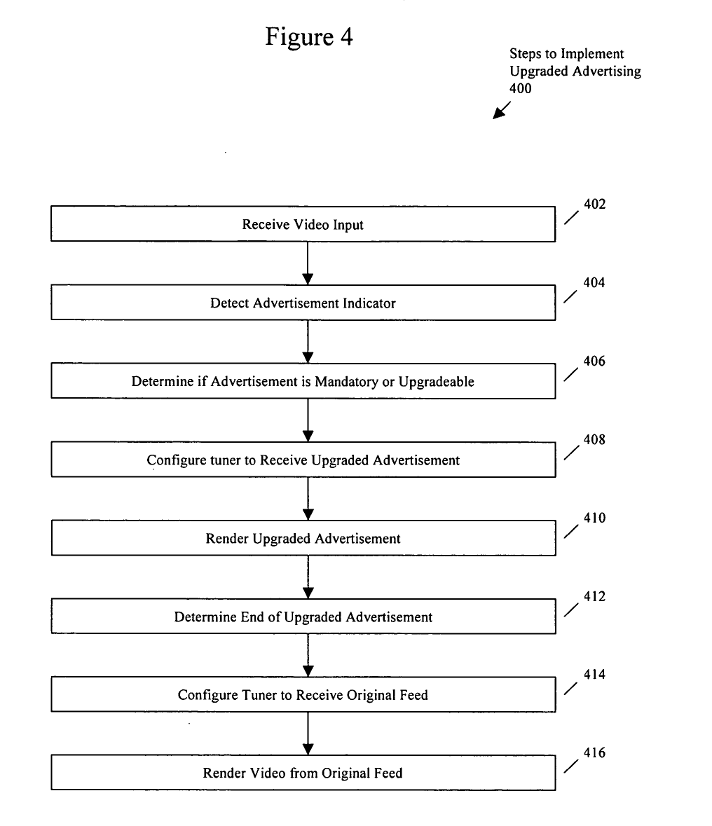

FIG. 4 is a flow diagram illustrating the steps performed by processor 306 in implementing real-time upgraded advertising. In real-time upgraded advertising, the upgraded advertisement is available at the same time as the advertisement which it replaces, or slightly beforehand. At step 403, the set top box of FIG. 3 receives video signal 302. The video signal is employed to display a program or other content. During reception of video signal 302, tag/marker detector 308 at step 404 detects an advertising indicator. The indicator, and information associated with the indicator, is provided to processor 306. At step 406, the processor 306 determines if an advertisement is a mandatory advertisement or if an upgraded advertisement may be shown and if so, which upgraded advertisement. Such determination may employ selection control information 310 that may specify types of advertisements that may be replaced by upgraded advertising and the type of upgraded advertising to be employed. Information defining where the upgraded advertisement may be accessed may be provided as part of the indicator information or may be pre-stored in selection control information 310. If it is determined at step 406 that the advertising may be upgraded, the processor 306, at step 408, configures tuner 304 to provide a specific MPEG stream contained in the present tuned frequency, as identified by packet IDs (PIDs), provided to audio/video processor 312. Alternatively, processor 306 configures tuner 304 to a different frequency containing an MPEG stream or analog signal of the upgraded advertising. Otherwise, the tuner configuration remains unchanged. At step 410, the advertisement is rendered by transmitting output signals from audio/video processor 312 to display unit 314. At step 412, the end of the display period for the upgraded advertisement is determined. Such determination may comprise detection of another indicator by tag/marker detector 308, or may comprise determining that a predefined number of frames have been present, or that a predefined amount of time has elapsed. After presentation of the advertisement has been completed, at step 414 the tuner is reconfigured as required to receive the original signal as employed in step 402. At step 416 the original video signal is rendered.

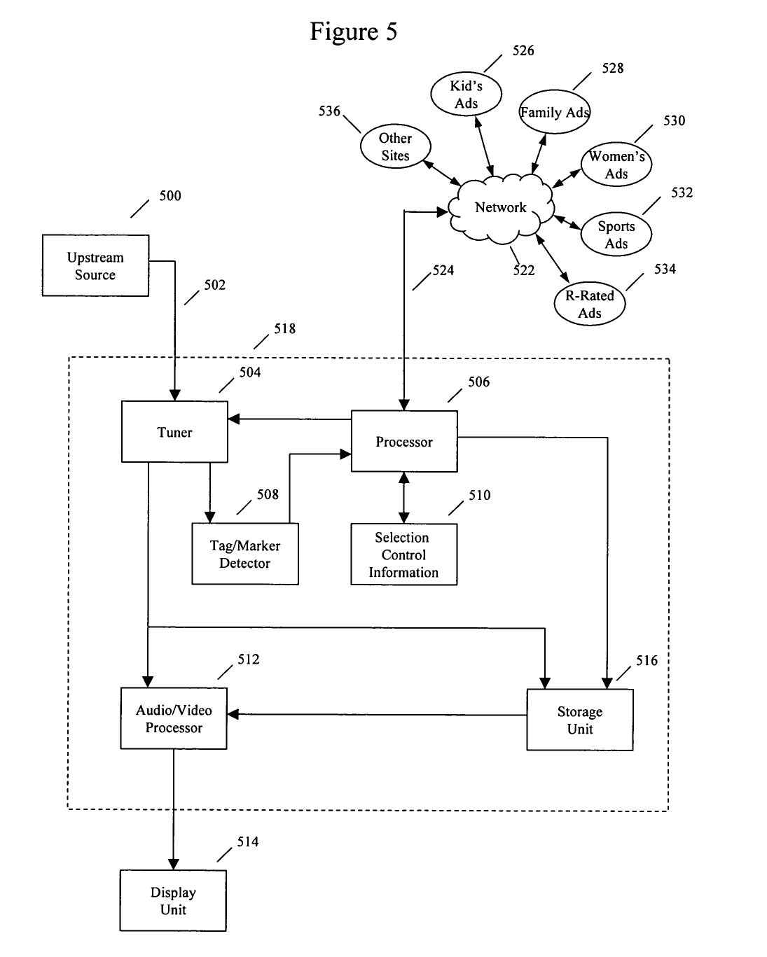

FIG. 5 is a schematic block diagram of another embodiment to the present invention. This embodiment is similar to that shown in FIG. 3 and is capable of operating as described in FIG. 4 and provides additional capabilities employing storage 516 and network interface 514. Upstream source 500 provides input signal 502 to set top box 518 and to tuner 504 that, under the control of processor 506, selects a frequency containing a video signal. As illustrated in FIG. 5, input 502 comprises an input source that may include a video signal such as an analog or digital signal that includes standard advertising during advertising periods and also may include triggers, tags and markers, or other indicators that identify and temporally define the advertising in the video stream. Again, the markers may provide information that describes whether an ad is a replaceable ad, a mandatory ad and/or the priority level of the ad. The signal 502 may include triggers that have embedded addresses for network or Internet sites, as explained in more detail below, and may include markers and/or tags that locate and identify the standard advertising segments that are contained in the video signal.

Tag/Marker detector 508 is responsive to tag and marker or other indicator information contained in the video signal and provides the indicator information to processor 506. Detector 508 may be operable to identify data packets and to selectively provide the packets to processor 506 or storage unit 516. Tuner 504 provides a selected signal to audio/video processor 512 that in turn provides audio and video signals to display unit 514. Upstream source 500 may provide upgraded advertising. The upgraded advertising may be part of a broadcast associated with a program, may be provided on a different frequency, and may be transferred as data packets and stored in storage unit 516 for later use. For example, the signal selected by tuner 504 may comprise multiple MPEG streams where one of the streams provides program content and another stream provides upgraded advertising. Alternatively, the signal selected by tuner 504 may provide an analog program and advertising. Upgraded advertising may be also provided on another tuned signal, or may be embedded in a digital format within the blanking intervals of an analog program. In contrast to the method of FIG. 4, the system of FIG. 5 may store upgraded advertisement data to storage unit 516 at any time, allowing a wider range of upgraded advertisements.

Processor 506 employs information from tag/marker detector 508 to identify upgraded advertising data and effects storage of the upgraded advertising data in memory 516. The upgraded advertising data may be contained in one MPEG stream of a plurality of MPEG streams received by tuner 504, or may be digitally encoded within the blanking interval of an analog program signal. Storage unit 516 may comprise RAM, Flash, Hard disk, or any other medium suitable for video storage. Alternatively, an encoder (not depicted) such as a MPEG or motion JPEG encoder, for example, may be employed to store analog format upgraded advertisements in storage unit 516. The above-described embodiments may also employ a second tuner (not depicted) to access and optionally access and store upgraded advertisement data.

When a marker indicates the initiation of an advertisement period, processor 506 determines if the advertisement may be upgraded, checks to determine if an upgraded advertisement is in memory 516, and controls transfer of the upgraded advertisement from memory 516 to audio/video processor 512. Storage unit 516 may be employed to store ads of different content. For example, one section of the memory may be dedicated to family ads, while other sections may be dedicated to women's ads, kids ads, sports ads, R-rated ads, or any other type of specified advertising for targeting certain individuals or groups.

In addition to receiving upgraded advertisement data in a broadcast signal, the set top box of FIG. 5 may also employ network connection 524 to access network 522 and access upgraded advertisement data. Network 522 may be any two-way network including the Internet, two-way cable and satellite networks, LANs, WANs and the like. Tag/marker detector 508 may detect, indicate and provide information to processor 506 so that processor 506 may determine that the data identified by tag/marker detector 508 is network address information associated with a selected upgraded advertisement category and the network address information may be stored in storage unit 516. Later when a tag, trigger or other indicator of an advertisement is detected, processor 506 may access the network address information and employ it to access upgraded advertisement data. Alternatively, processor may employ network address information to access upgraded advertisement data and store the data in storage unit 516 and then render the upgraded advertisement in response to a tag, marker or other advertisement indicator. Further, storage unit 516 may be employed to store a portion of an upgraded advertisement to accommodate network access latencies such that display of an upgraded advertisement may commence while processor 506 accesses the remainder of the advertisement across network interface 524.

Stored upgraded advertising information can be used multiple times over extended periods depending upon the storage capability of the storage unit 516 and the length of time and the number of times an advertisement is to be displayed. If the set-top box 518 is specifically programmed for only a certain type of upgraded advertising, the processor 506 will recognize the MPEG data packet headers for that category of upgraded advertising and can be programmed to only store that category of advertising, so as to reduce the storage requirements of storage unit 516.

The set-top box 518 can alternatively be programmed so that a remote control or other control device, such as disclosed above, can switch the set-top box 518 from one category of upgraded advertising to another. If this type of set-top box programming is employed, a range of upgraded advertisements may be stored and the capacity requirements for storage unit 516 may be greater.

An advantage of set top boxes that employ storage unit 516 to store upgraded advertisements is that a greater number of types of upgraded advertisements may be supported than if upgraded advertising is only provided on another analog channel or digital stream in a real time or in near real time manner relative to standard advertisements that may be replaced.

Another advantage of storing upgraded advertisements locally in the set top box is that a single channel or MPEG stream may be employed to transfer the advertising content, reducing bandwidth requirements and allowing the display of a greater number of programs with which advertising may be shown.

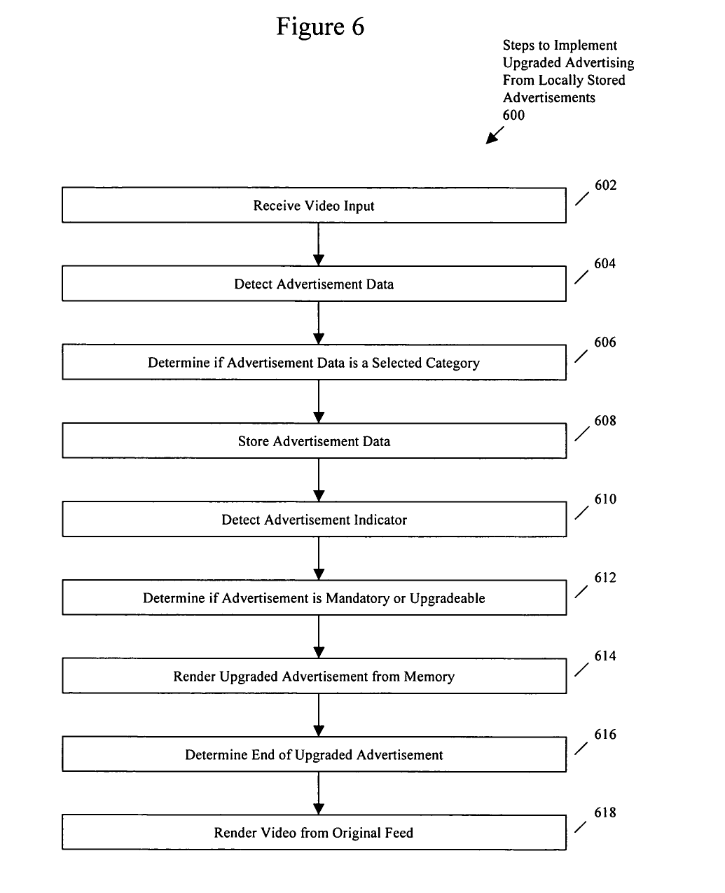

FIG. 6 is a flow diagram illustrating steps 506 performed to implement upgraded advertising using locally stored advertising content. At step 602, set top box 518 receives a video input and produces a display. At step 604, tag/marker detector 508 detects the presence of upgraded advertising content and forwards information regarding the content to processor 506. At step 606, processor 506 determines if the advertising content corresponds to a selected category of upgraded advertisements. If the content corresponds to a selected category, the advertisement content is stored in storage unit 516 at step 608. Steps 604 to 608 may be repeated multiple times to store a complete advertisement. At step 610, tag/marker detector 508 detects an advertising indicator. The indicator and information associated with the indicator is provided to processor 506. At step 612, processor 506 determines if an advertisement is a mandatory advertisement, or if an upgraded advertisement may be shown. Such determination may employ selection control information 510 that may specify types of advertisements that may be replaced by upgraded advertising and the type of upgraded advertising to be employed. Information defining a location in storage unit 516 and if storage of the advertisement is complete may be contained in selection control information 510, or may be provided as part of the advertisement indicator information. If it is determined at step 612 that the advertising may be upgraded, the processor 506, at step 614, configures audio/video processor 512 to receive upgraded advertising content from storage unit 516 at a time determined from advertising indicator information. Upgraded advertising content is transferred from storage unit 516 to audio/video processor 512 until the upgraded advertisement is completed. At step 616 the end of the upgraded ad is determined and may be indicated by detecting the end of the data, a predefined timed period, frame count, or other indictor detected by tag/marker detector 508. At step 618, audio/video processor 512 is configured to receive data from tuner 618 and video is rendered from the original signal.

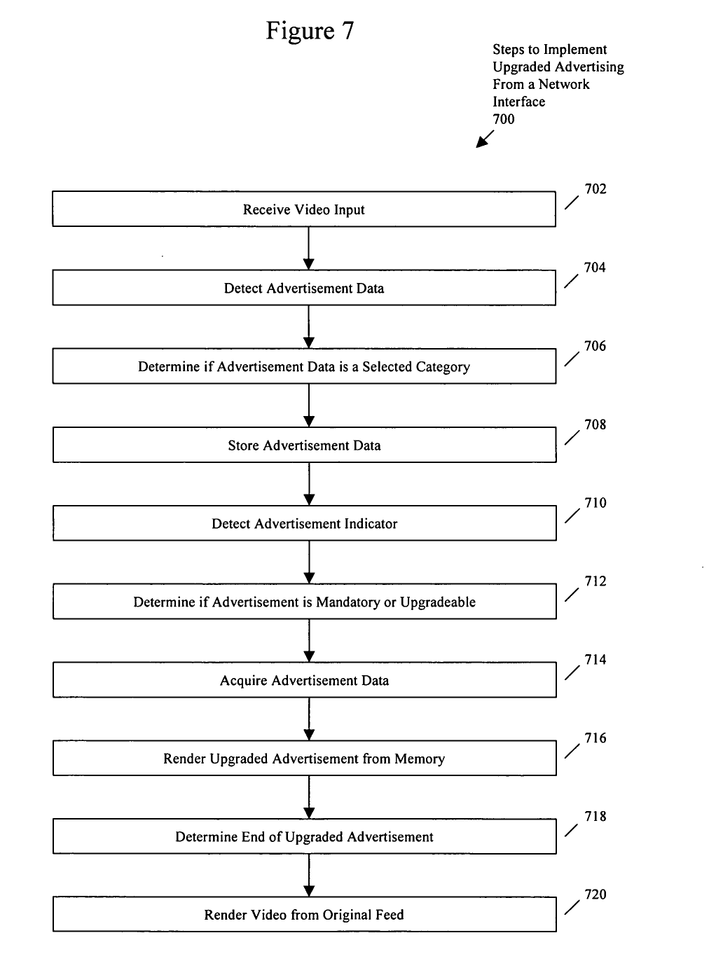

FIG. 7 is a flow diagram illustrating steps performed to implement upgraded advertising acquired over a network interface. At step 702, set top box 518 receives a video input and produces a display. At step 704, tag/marker detector 508 detects the presence of advertising data comprising advertisement category and access address and forwards the data, or a portion thereof, to processor 506. At step 706, processor 506 determines if the advertisement category corresponds to a selected category of upgraded advertisements. In all of the embodiments disclosed herein, the term category can comprise any desired type of selection criteria including ID information, category content, keywords, etc. If the category corresponds to a selected category, the advertisement category and access address data is stored in storage unit 516 at step 708. Steps 604 to 608 may occur multiple times to store addresses and categories for a plurality of selected advertisement categories. It is also within the scope of the embodiments of the present invention that priority levels may be assigned to standard and upgraded advertisements and the selection of an advertisement may employ category preference information, advertisement priority level, and the type of upgrade package implemented. Different upgrade packages may be configured to replace different priority levels of standard advertising such that higher-level packages may replace a greater number of standard advertisements. Further, key word parsing or other algorithms may be applied to descriptions of upgraded advertisements by the set top box to determine in an upgraded advertisement is desired, allowing finer granularity in advertisement selection than just categories. At step 710, tag/marker detector 508 detects an advertising indicator. The indicator and information associated with the indicator is provided to processor 506. At step 712, processor 506 determines if an advertisement is a mandatory advertisement or if an upgraded advertisement may be shown. Such determination may employ selection control information 510 that may specify types of advertisements that may be replaced by upgraded advertising and the priority of upgraded advertising. If it is determined at step 712 that the advertising may be upgraded, the processor 506, at step 714, acquires upgraded advertising content using network interface 524. The time at which upgraded advertising content is acquired may be specified by indicator information, or may be determined by the processor 506. In one embodiment, part or all of the upgraded advertising content is stored in storage unit 516 prior to rendering. If part of the upgraded advertising content is stored in storage unit 516 when rendering commences, the remaining portion of the content may be acquired and stored as portions of the content are rendered. Operation may be configured such that the stored portion of content is sufficient to accommodate network access latencies and transfer rates. In another embodiment, the network interface may provide content at a rate sufficient for real-time or near real-time streaming such that only a small portion, if any, of the content is stored in storage unit 516. At step, 716, the acquired advertising content is rendered. This may comprise configuring audio/video processor 512 to receive data from storage unit 516 or to receive streaming content from network interface 524 or processor 506. Upgraded advertising content is rendered using audio/video processor 512 until the advertisement is completed, which is determined at step 718 and may be indicated by the end of the data, a predefined timed period, frame count, or other indictor detected by tag/marker detector 508. At step 720, audio/video processor 512 is configured to again receive data from tuner 618.

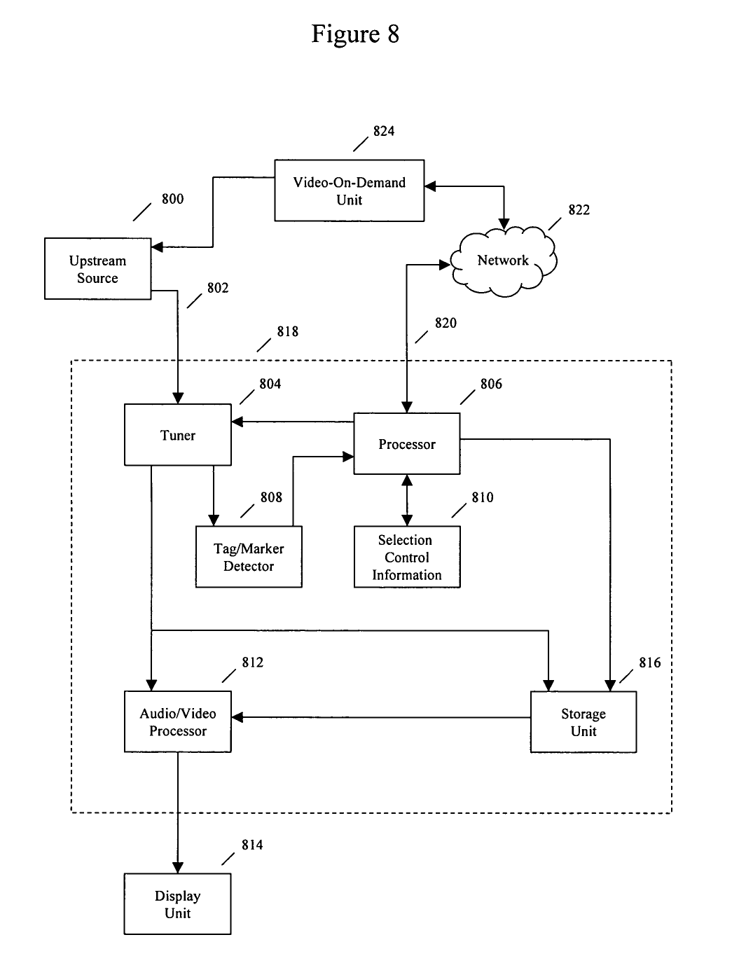

FIG. 8 is a schematic diagram of yet another embodiment of the present invention. This embodiment is similar to that of FIG. 5 and provides all the functions associated with FIG. 5 and additionally provides video-on-demand based upgraded advertising. As shown in FIG. 8, an upstream source 800 may comprise video with standard ads, triggers, tags, markers, other advertising indicators, and additionally may comprise upgraded advertising content from video-on-demand unit 824. Upstream source 800 provides video signal 802 to set top box 818. Alternatively, set top box 818 may employ network connection 820 to access upgraded advertising content from video-on-demand unit 812 via network 822. Network 822 may be any two-way network including LANs, WANs, and the Internet.

Input signal 802 is provided to tuner/decoder 804. Under control of processor 806, tuner 804 selects a frequency containing a video signal. Tag/Marker detector 808 is responsive to tag, marker, or other indicator information contained in the video signal and provides the information to processor 806. Tag/Marker 808 detector may support proprietary or public formats, or a combination thereof and may include support compliant with the Enhanced Content Specification of ATVEF (Advanced Television Enhancement Forum), for example. Tuner 804 provides the selected signal to audio/video processor 812 that, in turn, provides audio and video signals to display unit 814. Audio/video processor 812 may include MPEG decoding and analog signal processing. As in FIG. 5, upstream source 800 may include upgraded advertising. The upgraded advertising may be part of a broadcast associated with a program, or may be provided on a different frequency. For example, the frequency selected by tuner 804 may provide multiple MPEG streams where one of the streams provides program content and another stream provides upgraded advertising; or the frequency may provide an analog program and advertising. Upgraded advertising may be also provided on another frequency, or may be embedded in a digital format within the analog program blanking intervals.

Tag/marker detector 808 is responsive to advertising information contained in the video signal selected by tuner 804 and provides the information to processor 806. Advertising information may comprise selected categories, tables, executable code or other information that may be stored in selection control information 810, and further may comprise upgraded advertising content, descriptions of content, scheduling of advertisements, and addresses at which content may be accessed. The addresses may specify locations internal or external to set top box 818, and may specify an address that corresponds to video-on-demand unit 824. Processor 806 compares the advertising information with selected categories stored in selection control information 810 and performs a software controlled process to determine if standard or upgraded advertising will be displayed relative to an upcoming advertising event. Depending on standard advertising priority and the priority of upgraded advertising categories, processor 806 may affect display of the standard advertisement, an upgraded advertisement stored in storage unit 816, an upgraded advertisement accessed across network 822, or may issue a request to video-on-demand unit 824 for an upgraded advertisement. Such request may employ network 822 or an upstream channel (not depicted). Video-on-demand unit 824 may reside at a cable headend, or at a hub that is more localized to a group of viewers. When the availability of video-on-demand upgraded advertising is conveyed to set top box 818 through information provided by tag/marker detector 808 to processor 806, such information may include tuning information such that tuner 804 is configured to receive a video-on-demand transmission at a predefined time. The predefined time may correspond to the time at which the upgraded advertising content is to be displayed or may correspond to a time when bandwidth is available to transfer the content to storage unit 816. The tuner may employ a service channel (standard video broadcast channel) or an out-of band channel and may employ methods disclosed in U.S. patent application Ser. No. 09/915,114, filed Jul. 25, 2001 by Thomas Lemmons, entitled “Methods & Apparatus for Transmission of Interactive & Enhanced Television Data” which is specifically incorporated herein for all that it discloses and teaches.

Alternatively, video-on-demand unit 824 may be configured to provide upgraded advertising content across network 822 in a real-time or non-real-time manner such that the content may be streamed to audio/video processor 812 or may be stored in storage unit 816 for later display. Such delivery and display of upgraded advertising content may operate in a manner as described relative to FIG. 5. Embodiments of the present invention may also be used in conjunction with bandwidth optimization such as disclosed in U.S. patent application Ser. No. 09/935,873, filed Aug. 23, 2001, entitled “A System & Method for Optimizing Broadcast Bandwidth & Content,” by Thomas Lemmons.

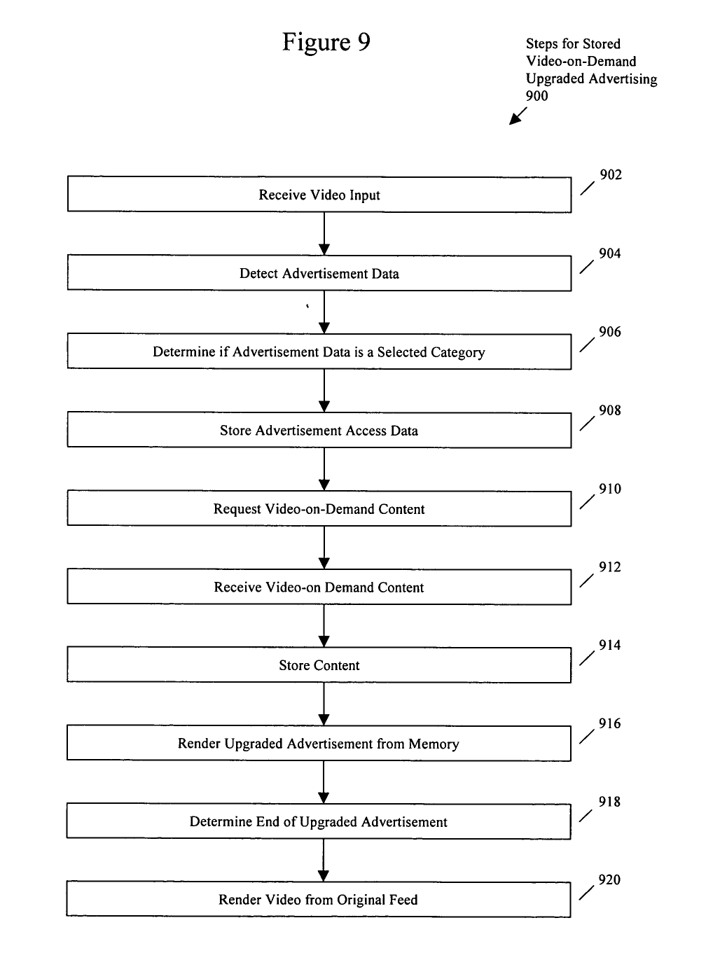

FIG. 9 is a flow chart illustrating steps performed to implement stored video-on-demand advertising. At step 902, tuner 804 is configured to supply a desired program to audio/video processor 812. At step 904, tag/marker detector 808 detects advertisement data in the video signal. At step 906, processor 806 determines if the advertisement data is for a selected category. If the advertisement data is for a selected category, the data is stored to storage unit 816 at step 908. At step 910, a request is issued to video-on-demand unit 824. The request may employ a network connection and may comprise upstream communication over a cable or satellite network. At step 912, content from video-on-demand unit 824 is received across network connection 820 or in the video signal, in which case, tag/marker detector 808 detects upgraded advertising content in the video signal and indicates the presence of the content to processor 806. At step 914 the content is stored in storage unit 816. At step 916, the upgraded advertising content is displayed from memory 816 at a time defined by initial advertising information or by subsequent information detected by tag/marker detector 808. At step 918 the end of the upgraded advertising is determined as previously described. At step 920, the audio/video processor is configured to receive data from tuner 804.

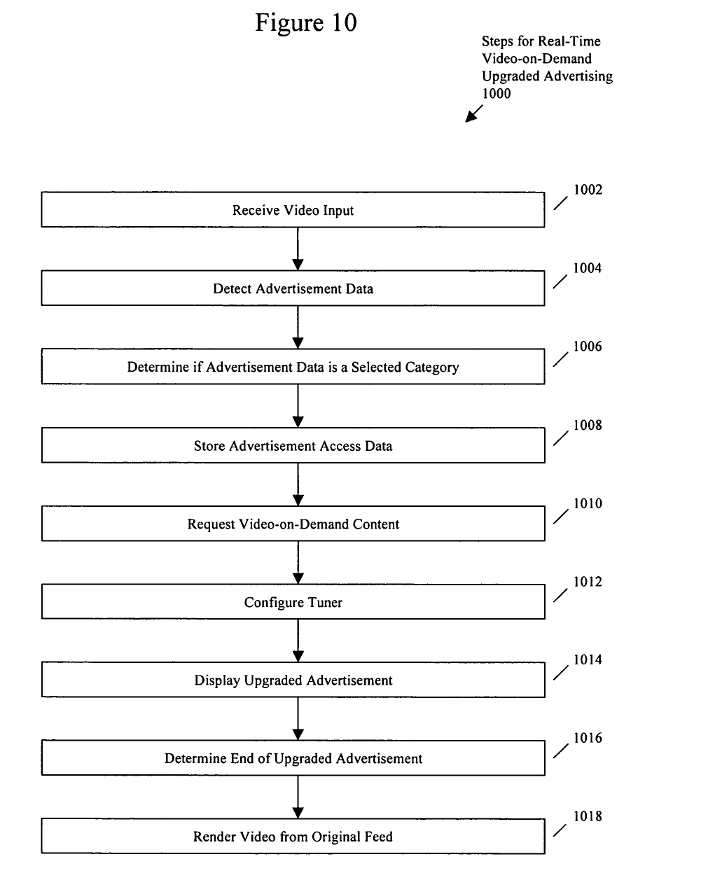

FIG. 10 is a flow chart illustrating steps performed to implement real-time video-on-demand advertising. At step 1002, tuner 804 is configured to supply a desired program to audio/video processor 812. At step 1004, tag/marker detector 808 detects advertisement data in the video signal. At step 906, processor 806 determines if the advertisement data is for a selected category and if the advertisement data is for a selected category, the data is stored to storage unit 816 at step 1008. At step 1010, a request is issued to video-on-demand unit 824. The request may employ a network connection and may comprise an upstream communication over a cable or satellite network. At step 1012, tuner 804 is configured to access a video signal containing content from video-on-demand unit 824. The time at which tuner 804 is configured to access the video-on-demand content may be specified in initial advertising information provided by tag/marker detector 808 to processor 806, or may be contained in subsequent information. The subsequent information may also include confirmation that the requested content shall be provided at a predetermined time. At step 1014, the upgraded advertising content is displayed. At step 1016 the end of the upgraded advertising is determined as previously described. At step 1018, the tuner is reconfigured as required to display the original video signal.

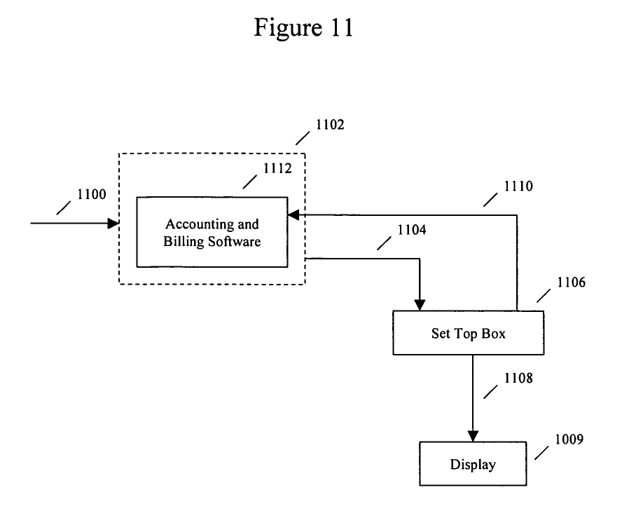

FIG. 11 is a schematic block diagram illustrating one manner in which the ad accounting and billing software can be implemented. As shown in FIG. 11, an input 1100 is applied to an upstream source 1102. Again, the upstream source can be any type of upstream source such as disclosed above. The upstream source transmits the input 1104 to various set-top boxes such as set-top box 1106. Upgraded ad information is provided, by any one of the methods disclosed herein, to generate a video with upgraded ads 1108. This information is then displayed on display 1109. Each time a particular ad is inserted into the video stream 1108, the set-top box generates a signal 1110 that constitutes an upgrade ad usage signal. This signal is transmitted back to the upstream source 1102 to accounting and billing software 1112. Alternatively, the set top box may accumulate a count of the number of times upgraded advertising is shown and may transfer this information to the accounting and billing software periodically or in response to a request for the information. The ad accounting and billing software 1112 counts the number of times a particular ad has been run on the set-top box 1106 and then may charge the advertiser for the display of those ads. Of course, the ad accounting and billing software can be located in any location and can be accessed over the Internet or other network. Further, the upgraded ad signal usage information 1110 can be sent over a back channel to the upstream source 1102, or any other desired connection such as a dial-up modem or other network or Internet connection. As previously noted, billing associated with upgraded advertising may be applied to advertisers or viewers, and viewers may receive awards, discounts or other benefits for view upgraded advertisements and groups of advertisements. The aforementioned accounting and billing software may be configured to support any or all of these methods either alone or in combination. Alternatively, a set top box may be configured to display a predetermined number of upgraded advertisements for a fee charged to the viewer or advertiser. Different types of upgraded advertisements may have different cost structures associated with them, including whether fees are charged to the viewer or the advertiser, or if awards or other benefits are provided to the viewer for watching upgraded advertisements or a group of upgraded advertisements. Further, viewers may receive access to different types of upgraded advertisements, at a reduced cost, or at no cost, if a predetermined number of advertisements in predefined categories have been viewed. Embodiments of the present invention employing pre-programmed set top boxes may include a monthly or other periodic fee charged to the viewer or advertiser(s).

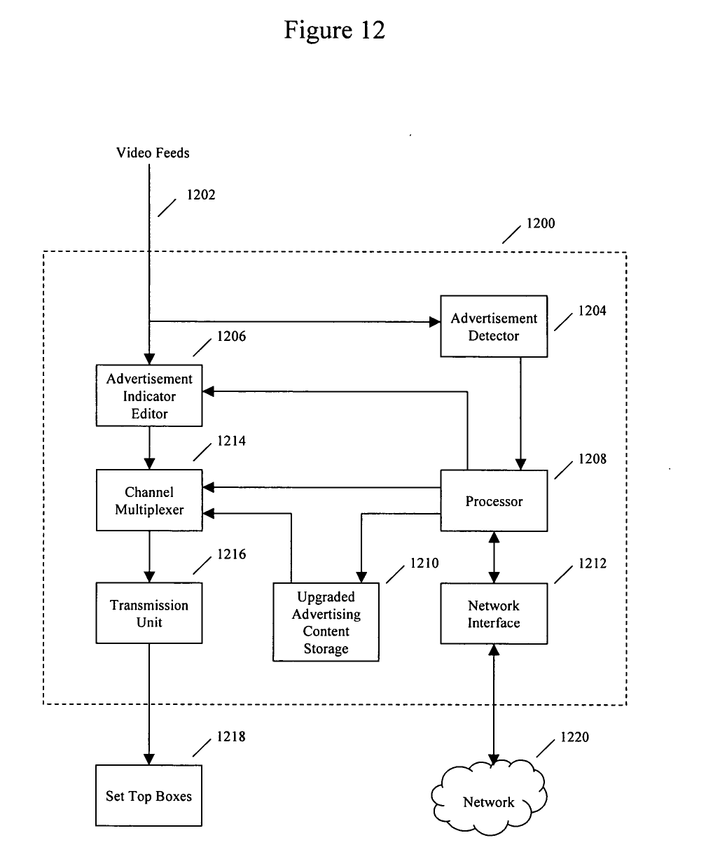

FIG. 12 is a schematic block diagram of an upgraded advertising system as may be implemented by a cable, satellite or other video services providers. System 1200 receives a plurality of video feeds 1202. Video feeds 1202 may be provided via cable, satellite, networks, or video storage equipment as is common to video service providers. Video feeds 1202 are supplied to advertisement detector 1204 and advertisement indicator editor 1206. Advertisement detector 1204 provides information regarding the scheduling, content, and upgradability of advertisements to processor 1208. Video feeds 1202 may comprise feeds from various national or regional networks and some advertising may be required to be shown, i.e., mandatory ads. Video feeds 1202 may also include upgraded advertising wherein the advertising may be included as part of the feed or may reference upgraded advertising content that is delivered at another time, or by other means such as network 1220 that may comprise any two-way network including LANs, WANs, and the Internet. Processor 1208 may employ information from advertisement detector, viewer category requests, set top box capabilities, and broadcast system capabilities to formulate a broadcast schedule. The broadcast schedule defines what upgraded advertising will be provided, at what time the upgraded advertisements will be provided, if the upgraded advertisement content will be provided in a real-time or non-real time manner, or if pre-stored content will be employed, scheduling of transmission of advertisement indicators, and the manner of delivery of the content including channel or MPEG stream, network, out-of-band channel, etc. Processor 1208 provides scheduling information to advertisement indicator editor 1206. Advertisement indicator editor creates, adds, deletes, or modifies advertisement indicators for video feeds 1202. Advertisement indicator editor may comprise hardware and/or software components and processor 1204 may execute portions of the software. Video feeds with edited advertisement indicators are provided to channel multiplexer 1214. Channel multiplexer 1214 is employed to assign an analog channel or MPEG stream to each video feed. Video Feeds may be demodulated prior to input to being input to advertisement indicator editor 1206 and then may be modulated on the same or different frequency depending upon the channel or MPEG stream assigned by channel multiplexer 1214. Such practice is common in the cable television industry where a video feed received on one channel may be re-modulated to a different channel when broadcast. Channel multiplexer 1214 is also configured to receive upgraded advertising content from upgraded advertising content storage 1210. Upgraded advertising content storage 1210 may contain advertisement content previously provided on one or more video feeds 1202 or acquired from network 1220. Channel multiplexer 1214 can provide a plurality of video signals; comprising video content, advertisement indicators, and advertising content; wherein the video signals are each assigned to a different channel or MPEG stream for transmission, to transmission unit 1216. Transmission unit 1216 provides the plurality of video signals to set top boxes 1218.

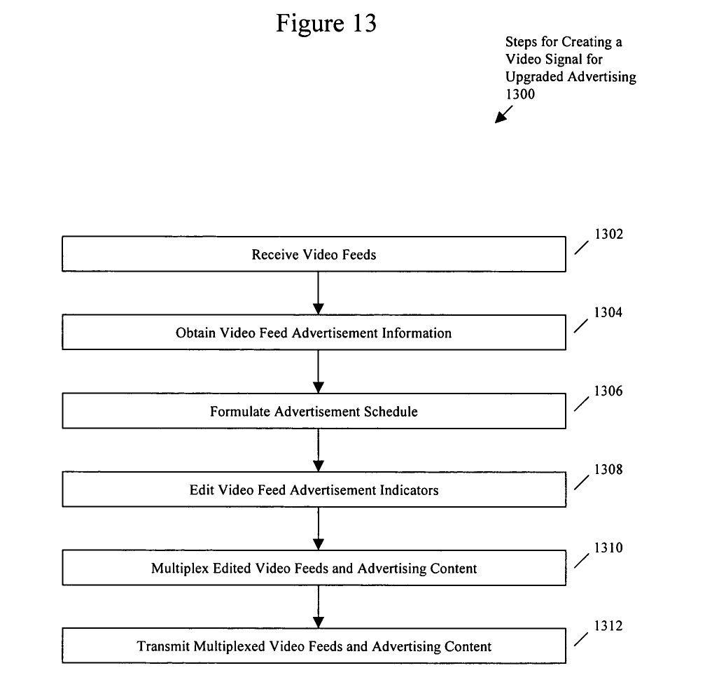

FIG. 13 is a flowchart illustrating steps performed in producing a video signal supporting upgraded advertising. At step 1302, system 1200 receives a plurality of video feeds. As noted above, the video feeds may be provided via cable, satellite, networks, or video storage equipment and may contain standard advertising or upgraded advertising. At step 1304, advertisement detector 1204 acquires advertisement information from video feeds 1202 and provides the information to processor 1208. Acquisition of advertisement information may comprise acquiring embedded information in the video feeds and/or may comprise analysis of advertisement by computer and/or human means. The advertisement information may include scheduling, category, upgrade priority, content description or other information. At step 1306, processor 1208 employs advertisement information obtained from advertisement detector 1204, viewer category requests, set top box capabilities, and broadcast system capabilities to formulate a broadcast schedule. Categories that exhibit higher numbers of requests may result in advertisements in those categories being presented more frequently than advertisements for categories receiving fewer requests. Information may be extracted from the broadcast schedule and may be supplied to the accounting and billing software of an embodiment of the present invention. At step 1308 of FIG. 13, advertisement indicator editor 1206 is employed to edit (add, delete, or modify) advertisement indicator information of video feeds 1202. If a video signal of video feeds 1202 includes upgraded advertising, advertisement indicator editor 1206 may leave the associated indicator unchanged, may modify the indicator to reference different content associated with the same advertising category, may assign a new advertising category, or may delete the indicator. Further, advertisement indicator information provided by video feeds 1202 may specify if advertising contained in the feed may be upgraded depending on the advertising system receiving the feed. In other words, national broadcasters may specify that advertisements contained in the national broadcast may be upgraded in some areas, but must be shown in other areas. Video feeds with edited advertisement indicators are provided to channel multiplexer 1214. At step 1310, channel multiplexer 1214 assigns a channel or MPEG stream to each video feed and each instance of upgraded advertising content accessed from upgraded advertising content storage 1210. Channel multiplexer 1214 may modify packet IDs of the edited video feeds and may packetize and assign packet IDs to upgraded advertising content accessed from upgraded advertising content storage 1210. Channel multiplexer 1216 may also group MPEG streams if multiple streams are encoded together, as is common for QAM (Quadrature Amplitude Modulation) formats. Channel multiplexer 1214 outputs video signals to transmission unit 1216 that at step 1312 transmits the video signals to set top boxes 1218.

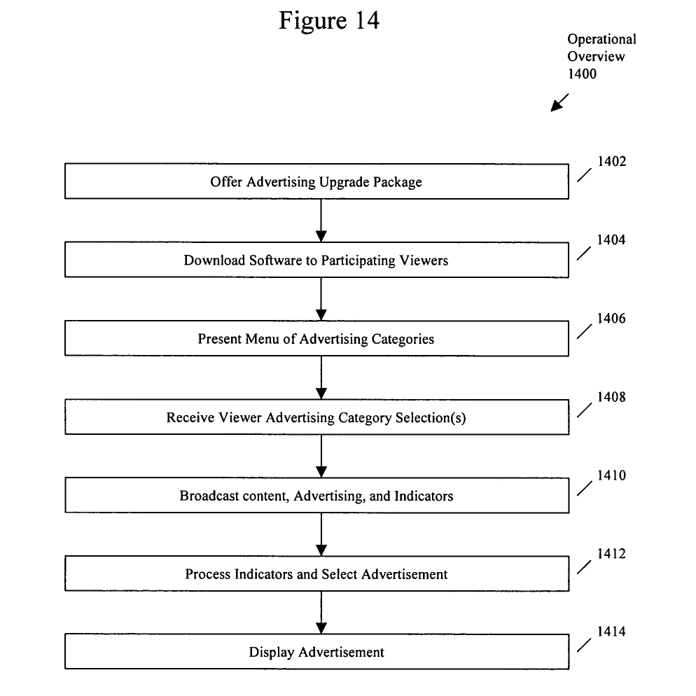

FIG. 14 is an operational overview of an upgraded advertising system. At step 1402, an offer for upgraded advertising is provided to viewers. This may comprise television, mail, Internet, or other promotion. At step 1404, requests for upgraded advertising are received from viewers and upgraded advertising computer program code is downloaded to the viewer's set top box. Various versions of the code may be downloaded depending on the upgrade package selected (if multiple versions are offered) and depending on set top box capabilities. Download may employ a satellite, cable, terrestrial, Internet, or other network. Alternatively, a subscriber may receive a pre-programmed set top box, or may receive a CDROM, diskette or other media containing the upgraded advertising computer program code. At step 1406, a menu of advertisement categories may be presented to the viewer for selection or exclusion. At step 1408, a viewer may select one or more advertising categories. Viewer selections may configure the computer program code to selectively replace advertising as previously described. In one embodiment, category information is transferred to upstream equipment and may be employed to create an advertisement broadcast schedule. At step 1410, program content, advertising, and advertising indicators are broadcast to a plurality of set top boxes. At step 1412, a set top box tuned to receive a specific program receives the broadcast and processes advertising indicators. As previously described, indicators may be provided for standard advertising (advertising provided in conjunction with a currently viewed program) and for “upgraded” advertisements. Upgraded advertisements may be advertisements shown in conjunction with programs on non-viewed channels or may be provided on another channel or MPEG stream without association to any particular program. The set top box computer program code processes the indicators and determines if a “standard” advertisement shown in conjunction with a viewed program corresponds to a selected category. If the advertisement does not correspond to a selected category, program code in the set top box determines (from the indicators received and from set top box memory if advertisements are stored in the set top box), if upgraded advertising of a selected category is available and if the standard advertisement may be upgraded as specified by priority level. Indicators may be provided in advance of a commercial break, allowing sufficient time to process indicators and configure tuning, local access (for set top boxes with local advertisement storage), or network access. At step 1414, the standard advertisement is shown if no upgraded advertisements of a selected category are available or if the priority of the standard advertisement is higher than upgraded advertisements. Otherwise, an upgraded advertisement is accessed from another channel, MPEG stream, local memory, or network connection, as previously disclosed, and is displayed. The process of displaying upgraded advertisements may also include showing a plurality of shorter duration upgraded ads during a standard ad or may include replacing a plurality of standard ads with one longer upgraded ad.

The term advertisement may refer to any program containing product promotion information and may include “infomercials” or programs with embedded advertising. Further, standard advertising may comprise modification of a broadcast program and upgrades of the standard advertising may comprise replacement, alteration, or combination of the standard advertisement with upgraded advertisement information. The foregoing embodiments furnish systems and methods of providing upgraded advertising. Embodiments that employ an address supplied as part of an advertisement indicator may also employ address modification wherein the processor of the set top box may alter the address or add an extension to an address to select or access an upgraded advertisement.

Further, a viewer may select multiple categories of upgraded advertisements and may specify a ranking or priority of categories in the event that two categories are available at one time. For example, a viewer may intend to purchase an automobile and may select an automobile advertisement category. The viewer may also be interested in musical instruments, for which advertisements are infrequent. The viewer may elect to have a musical instrument ad preempt other ads.

Real-time upgraded advertising as disclosed above relative to FIGS. 3 and 4 has the advantage of not requiring memory to store advertising data but also limits the number of categories that may be simultaneously supported. As such, a system operator may apply a processing procedure to requests received for categories to determine which categories will be supported at any point in time. The configuration of a broadcast comprising programs, advertising and upgraded advertising may employ methods disclosed in U.S. patent application Ser. No. 10/080,996, filed Feb. 20, 2002, by Thomas Huber and Ian Zenoni, entitled “Content Based Video Selection,” which is specifically incorporated herein for all that it discloses and teaches.

Embodiments of the present invention may also be used in conjunction with interactive hot spots and hot labels such as disclosed in U.S. patent application Ser. No. 10/212,289, filed Aug. 2, 2002, entitled “Post Production Visual Alterations,” by Thomas Lemmons and U.S. patent application Ser. No. 10/041,881, filed Oct. 24, 2001, entitled “Creating On-Content Enhancements,” by Gary Rasmussen, Steven 0. Markel, Ian Zenoni, Steven Reynolds and Thomas Huber. Both of these applications are specifically incorporated herein by reference for all that they disclose and teach. For example, a set top box may display upgraded advertising and may employ methods of the above-mentioned applications to access interactive sites for ordering products and services. In addition, information may be provided by set top box to indicate to the advertiser that the corresponding advertisement is an upgraded advertisement. Further, the advertiser may extend discounts to the viewer. The viewer may also be able to obtain express ordering and other services and may be able to obtain services not provided with mandatory advertisements.

In another embodiment of the present invention, stored upgraded advertising, streamed upgraded advertising accessed across a network, or upgraded advertising simultaneously accessed on another channel or MPEG stream, may be combined with a standard or mandatory advertisement. Such combination may employ methods disclosed in U.S. patent application Ser. No. 10/103,545, filed Mar. 20, 2002, by Steve Reynolds and Thomas Lemmons, entitled “Video Combiner”, which is specifically incorporated herein for all that it discloses and teaches. A standard or mandatory advertisement may be enhanced, modified, or otherwise altered through combination of the standard/mandatory advertisement with audio, graphics, images, and/or video associated with upgraded advertising information. As such, upgraded advertising allows local content, such as local dealer and vendor information, pricing, special offers, coupons, and the like to be displayed in conjunction with a standard/mandatory advertisement. As previously disclosed, hot spots may be associated with screen locations, allowing information stored locally in a set top box or network based information to be accessed by selecting a hot spot with a pointing device such as a mouse, remote control, and the like. Further, upgraded advertising information may be employed to add humor, highlights, additional information (such as trivia snippets seen on music videos), animated sequences, and any other visual or audio effects as may be created by combination of the upgraded advertising with a standard/mandatory advertisement.

Further yet, upgraded advertising information may be employed to provide images that appear conformally mapped to a surface of an image displayed in a standard/mandatory advertisement. As such, brand names, local dealer information, information types disclosed above, and any other information, may be mapped to the surface of a product, such as a refrigerator, for example. Images may be mapped to virtually any image providing sufficient area to display information and may include automobiles, baseball stadium surfaces, billboards, etc. Such mapping may employ methods disclosed in U.S. patent application Ser. No. 10/212,289, filed Aug. 2, 2002, by Thomas Lemmons, entitled “Post Production Visual Alterations”, which is specifically incorporated herein for all that it discloses and teaches. It should be noted that methods of the above mentioned patents may be used with methods of the Video Combiner. The methods disclosed in these patent applications, and methods of the present invention, may be employed to produce enticing visual effects. For example, through combination of an upgraded advertisement with a standard advertisement employing video combination and conformal mapping, a bathing beauty, sea monster, etc., may appear to shimmer on the surface of a swimming pool. Images created in such a manner may provide advertising information or may spur viewer interest through information, humor, and son on as disclosed above.

Advantageously, embodiments of the present invention may be employed to provide a finer granularity in advertisement focus. For example, manufacturers or dealers of musical instruments infrequently purchase television-advertising time. By employing viewer selected advertising packages, an advertiser may reduce advertising cost by only advertising to those with a higher likelihood of product interest while a broadcast system operator may increase revenue by charging a higher per person cost for packaged advertising and through possible viewer charges.

Some embodiments of the present invention may be employed without viewer interaction such that advertising may be tailored to characteristics of the viewer as may be determined by demographic or other information that may be available from viewing habits, products ordered, or other sources. In such cases, selection control information may be transferred to a set top box independent of viewer interaction

It should be noted that the various embodiments of set top boxes disclosed above may all be co-resident in a video system, along with set top boxes that do not implement any of the functions associated with the present invention, and that through software installed or downloaded to the set top boxes, each set top box may operate within the limit of its capabilities, allowing a range of services to be provided in a single network. For example, set top boxes as described relative to FIG. 3 may respond only to real-time upgraded advertisements and would not respond to downloaded advertisement information, while set top boxes as disclosed in FIGS. 5 and 8 would respond to downloaded advertisement information.

The various embodiments disclosed herein therefore provide a system and method for sending upgraded advertising information to viewers based upon viewers selected preferences for advertising. Upgraded advertising can be provided as a standard upgraded advertising package in which the viewer can select the desired upgraded advertising, as the viewer desires, or can be provided as preprogrammed set-top boxes that may be rented by the advertiser. Any type of category of advertising can be provided. In addition, upgraded ads can be interspersed with mandatory ads that cannot be replaced by the upgraded ads. Alternatively, upgraded advertising packages may be provided without the necessity for mandatory ads, such that the upgraded advertising includes ads that will be displayed to insure certain advertising revenue. Upgraded advertising information can be provided as part of the input to an upstream source, may be downloaded by an upstream source, or by a set-top box via a network connection, a modem or other network connection. Indicators may be associated with some or all of the advertisements broadcast. Advertisements without indicator information may be processed as mandatory ads. The various embodiments disclose various ways of processing and retrieving the information and provide a new and unique method for increasing advertising revenue and for increasing the enjoyment of viewing by the viewer. References made herein to the ATVEF specification are made for illustrative purposes only, and such references should not be construed as an endorsement, in any manner, of the ATVEF specification.

The indicators and categories of embodiments or the present invention may also be employed to exclude specific types of advertisements or to exclude individual advertisements as desired by the viewer. For example, a viewer may elect to exclude all beer and wine advertisements. Further, a viewer interested in automobiles and receiving upgraded advertisements for automobile may choose to exclude one or more automobile advertisements, as may result from having already viewed the advertisement. Alternatively, a viewer may choose to exclude an advertisement for reasons such as repetition, annoying format, product disinterest, or other reasons. Such advertisements may be replaced by other advertisements if the advertisement is not mandatory or if the upgrade priority is of a sufficient level.

Advantageously, embodiments of the present invention employing local advertising storage and network interfaces may be employed to display viewer specific advertising. Requests from viewers for specific products or services may be processed by servers that perform a search for corresponding advertising. As such, advertising for seldom viewed products may be presented to interested viewers.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of presenting advertising in a subscriber broadcast system comprising:
offering an upgraded advertising service;
receiving subscriptions to said upgraded advertising service;
delivering set top box computer program code to a plurality of upgraded advertising service subscribers;
receiving a plurality of video feeds including a plurality of advertisements;
providing indicators for at least two advertisements of said plurality of advertisements wherein said indicators include a priority level and a category for a corresponding advertisement;
broadcasting a video signal comprising program content, said plurality of advertisements, and said indicators for at least two advertisements of said plurality of advertisements to a plurality of set top boxes.

2. The method of claim 1 further comprising:
receiving a request for an advertising category from at least one subscriber of said plurality of subscribers.

3. The method of claim 1 further comprising:
broadcasting an advertising indicator that includes a network address for an advertisement that can be accessed across a network.

4. The method of claim 1 further comprising:
downloading an advertisement and corresponding indicator to local storage of a set top box.

5. The method of claim 1 further comprising:
selecting said plurality of advertisements based upon demographic characteristics of said plurality of set top boxes.

6. A method for displaying user selected advertising in a subscriber broadcast system comprising:
requesting a category of advertisement from a plurality of advertisement categories;
receiving a video signal comprising program content, a standard advertisement, and an advertisement indicator;
determining if said standard advertisement may be replaced with an upgraded advertisement;
accessing upgraded advertisement content if it is determined that said standard advertisement may be replaced with an upgraded advertisement; and
displaying said upgraded advertisement content if it is determined that said standard advertisement may be replaced with an upgraded advertisement.

7. An upgraded advertising production system comprising:
a processor;
an advertisement detector receiving a video feed comprising program content and advertising;
an advertisement indicator editor that can create, modify, and delete at least one advertisement indicator associated with an advertisement contained in said video feed;
a channel multiplexer that receives said program content, at least one advertisement, and said at least one advertisement indicator and that formats said program content, said advertisement and said at least one advertisement indicator for transmission; and
a transmitter that transmits said program content, said advertisement, and said at least one advertisement indicator.

8. A set top box that selectively displays upgraded advertising comprising:
a processor;
an audio/video processor that outputs audio and video signals to a display unit;
a tuner controlled by said processor that receives a video input comprising program content, a first advertisement, a first advertisement indicator, a second advertisement, and a second advertisement indicator wherein said first advertisement indicator and said second advertisement indicator both include a category of the advertisement and a priority level;
first computer program code operating on said processor that detects said first advertisement indicator and said second advertisement indicator and compares the category of said first advertisement and the category of said second advertisement to a stored category value and that compares the priority level of said first advertisement with the priority level of said second advertisement and that selects said first advertisement unless the category of said second advertisement is in agreement with said stored category value and the priority level of said second advertisement is greater than or equal to said priority level of said first advertisement;
second computer program code that provides said first advertisement to said audio/video processor if said first advertisement is selected and that accesses and provides said second advertisement to said audio/video processor if said second advertisement is selected.

9. The set top box of claim 8 further comprising computer program code that processes a user input and stores said stored category value in said set top box.

10. The set top box of claim 8 further comprising computer program code that recognizes a remote control input as being specific to one user and selects said stored category value from a plurality of stored category values based upon an identifier of said one user.

11. The set top box of claim 8 wherein said second computer program code further comprises code that adjusts said tuner to receive said second advertisement.

12. The set top box of claim 8 wherein said second computer program code further comprises code that acquires said second advertisement across a network.

13. The set top box of claim 8 further comprising:
a video combiner that combines a portion of said first advertisement with a portion of said second advertisement.

14. An upgraded advertising production system comprising:
processing means;
means for detecting an advertising period in a video feed;
editing means that can create, modify, and delete an advertisement indicator associated with said video feed to produce an edited video feed;
multiplexer means that receive said edited video feed and accesses advertising content and that formats said edited video feed and said advertising content for transmission; and
transmission means that transmits said edited video feed and said advertising content.

15. A set top box that selectively displays upgraded advertising comprising:
processor means;
audio/video processing means that output audio and video signals to a display unit;
tuning means controlled by said processor means that receive a video input comprising program content, a first advertisement, a first advertisement indicator, a second advertisement, and a second advertisement indicator wherein said first advertisement indicator and said second advertisement indicator both include a category of the advertisement and a priority level;
computer program code means operating on said processor that detect said first advertisement indicator and said second advertisement indicator and that compare the category of said first advertisement and the category of said second advertisement to a stored category value and that compare the priority level of said first advertisement with the priority level of said second advertisement and that select said first advertisement unless the category of said second advertisement is in agreement with said stored category value and the priority level of said second advertisement is greater than or equal to said priority level of said first advertisement;
second computer program code means that provide said first advertisement to said audio/video processor if said first advertisement is selected and that accesses and provide said second advertisement to said audio/video processor if said second advertisement is selected.

16. A method of operating a subscriber broadcast system comprising:
defining a plurality of advertising categories;
receiving user requests for said advertising categories;
transmitting program content and advertisements with advertisement indicators allowing selection of advertisements at a set top box;
determining a count of advertisements viewed in each category of said plurality of advertising categories; and
creating a billing statement reflecting said count of advertisements in each category.
